(19) United States
(12) Patent Application Publication
(10) Pub. No.: US 2025/0373529 A1
(43) Pub. Date: Dec. 4, 2025

(54) METHOD AND APPARATUS FOR DETERMINING LINK ASYMMETRY DELAY

(71) Applicant: Telefonaktiebolaget LM Ericsson (publ), Stockholm (SE)

(72) Inventors: Jun WANG, Beijing (CN); Michael Sien-Tsieh CHEN, Houston, TX (US); Zhiwei GAO, Beijing (CN); Baojian SUI, Beijing (CN); Jun DENG, Beijing (CN)

(21) Appl. No.: 18/873,971

(22) PCT Filed: May 30, 2023
(86) PCT No.: PCT/CN2023/097028

§ 371 Date: Dec. 11, 2024

(30) Foreign Application Priority Data
Jun. 17, 2022 (WO) PCT/CN2022/099436

(51) Int. Cl. H04L 43/0852

(52) U.S. Cl. CPC H04L 43/0852

(57) ABSTRACT

Embodiments of the present disclosure provide methods and apparatuses for determining link asymmetry delay. A method performed by a network node may include determining a first difference of a time error of a first port of a network node and a time error of a second port of the network node. The method may further include determining a second difference of a time error of the first port of the network node and a time error of the second port of the network node after a receiving link and a transmitting link of the first port are flipped. The method may further include determining a delay asymmetry value of the first port of the network node based on the first difference and the second difference.

### TECHNICAL FIELD

The non-limiting and exemplary embodiments of the present disclosure generally relate to the technical field of communications, and specifically to methods and apparatuses for determining link asymmetry delay.

### BACKGROUND

This section introduces aspects that may facilitate a better understanding of the disclosure. Accordingly, the statements of this section are to be read in this light and are not to be understood as admissions about what is in the prior art or what is not in the prior art.

In a communication system, clock synchronization may be required. For example, a network node may have to be synchronized to a global time to determine the beginning and the end of timeslots. A synchronization algorithm is needed to compensate offset and drift-rate of the node clock in respect to the global-time.

International Telecommunication Union (ITU) Telecommunication Standardization Sector (ITU-T) G.8271.1, the disclosure of which is incorporated by reference herein in its entirety, specifies the maximum network limits of phase and time error that shall not be exceeded. In a chain of time clocks, where N nodes are indexed by the letter i, and (N−1) links are indexed by the letter j, the maximum absolute TE (time error) at the output of the Nₜₕ node can be upper bounded as (Equation IV-13):

$$max \vert {TE}_{N} \vert \leq {\sum }_{i = 1}^{N} \vert {cTE}_{i} \vert + {\sum }_{j = 1}^{N - 1} \vert {linkTE}_{j} \vert + \sqrt{\{ {\sum }_{i = 1}^{N} {[ max \vert {dTE}_{L , i} ( t ) \vert ]}^{2} \} + {[ max \vert {dTE}_{H , N} ( t ) \vert ]}^{2}} \qquad ( IV ‐ 13 )$$

More generally, in a chain of time clocks, to a first order approximation:
the constant TE, and link asymmetry, accumulates linearly.
the low-band dynamic TE accumulates incoherently.
the high-band dynamic TE is contributed mainly by the last element in the chain.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Link asymmetry is a part which could have impact on the Time Error of the end node of a time clock chain. Generally, link asymmetry may be compensated by an operator. But how to measure the link asymmetry is a problem.

The link asymmetry could be removed by using a device to measure and compensate it. For example, OTDR (optical time domain reflectometer) could be used to measure the length of link (e.g., fiber) and calculate the asymmetry of receiving (RX) link and transmitting (TX) link. But the device needs cost and complex. ODTR may not measure the actual port to port fiber length between Telecom Boundary Clocks (T-BCs).

In addition, if the link asymmetry cannot be removed, then the time error cannot be measured or computed accurately. For example, if a customer want to measure the difference of the time error of PASSIVE port and the time error of SLAVE port according to ITU-T G.8275.1 Annex G, the customer may get a wrong result due to the link asymmetry.

To overcome or mitigate at least one of the above mentioned problems or other problems, an improved solution for determining link asymmetry delay may be desirable.

In a first aspect of the disclosure, there is provided a method performed by a network node. The method may comprise determining a first difference of a time error of a first port of a network node and a time error of a second port of the network node. The method may further comprise determining a second difference of a time error of the first port of the network node and a time error of the second port of the network node after a receiving link and a transmitting link of the first port are flipped. The method may further comprise determining a delay asymmetry value of the first port of the network node based on the first difference and the second difference.

In an embodiment, determining a delay asymmetry value of the first port of the network node based on the first difference and the second difference may comprise determining the delay asymmetry value of the first port of the network node by the second difference subtracting the first difference.

In an embodiment, the method may further comprise providing the delay asymmetry value to an operator.

In an embodiment, the method may further comprise using the delay asymmetry value as a compensation value of the first port.

In an embodiment, the first difference may be an average value of two or more first differences of two or more time errors of the first port and two or more time errors of the second port.

In an embodiment, the second difference may be an average value of two or more second differences of two or more time errors of the first port and two or more time errors of the second port.

In an embodiment, the time error may be measured by the network node or obtained from a time error measurement device.

In an embodiment, the time error may be measured by reception and transmission of event messages for carrying timestamps between a master clock and a slave clock.

In an embodiment, a timing signal received by the first port and the second port may comprise a timing signal of a Precision Time Protocol (PTP) clock.

In an embodiment, the first port may be a PTP port in a slave state and the second port may be a PTP port in a passive state.

In an embodiment, the first port may be a PTP port in a passive state and the second port may be a PTP port in a slave state.

In an embodiment, the first port may be a PTP port in a passive state and the second port may be a PTP port in a passive state.

In an embodiment, the receiving link may comprise a fiber link and/or the transmitting link may comprise a fiber link.

In an embodiment, the method may further comprise configuring a PTP clock, the first port and the second port. The method may further comprise configuring a monitor function according to International Telecommunication Union (ITU) Telecommunication Standardization Sector (ITU-T) G.8275.1 Annex G. The method may further comprise configuring a time period of measurement and a number of time periods. The method may further comprise collecting a first measurement data set. The method may further comprise collecting a second measurement data set after the receiving link and the transmitting link of the first port are flipped.

In a second aspect of the disclosure, there is provided a network node. The network node may comprise a processor and a memory coupled to the processor. Said memory contains instructions executable by said processor. Said network node is operative to determine a first difference of a time error of a first port of a network node and a time error of a second port of the network node. Said network node may be further operative to determine a second difference of a time error of the first port of the network node and a time error of the second port of the network node after a receiving link and a transmitting link of the first port are flipped. Said network node may be further operative to determine a delay asymmetry value of the first port of the network node based on the first difference and the second difference.

In a third aspect of the disclosure, there is provided a network node. The network node may comprise a first determining module configured to determine a first difference of a time error of a first port of a network node and a time error of a second port of the network node. The network node may further comprise a second determining module configured to determine a second difference of a time error of the first port of the network node and a time error of the second port of the network node after a receiving link and a transmitting link of the first port are flipped. The network node may further comprise a third determining module configured to determine a delay asymmetry value of the first port of the network node based on the first difference and the second difference.

In an embodiment, the network node may further comprise a providing module configured to provide the delay asymmetry value to an operator.

In an embodiment, the network node may further comprise a using module configured to using the delay asymmetry value as a compensation value of the first port.

In an embodiment, the network node may further comprise a first configuring module configured to configure a PTP clock, the first port and the second port.

In an embodiment, the network node may further comprise a second configuring module configured to configure a monitor function according to International Telecommunication Union (ITU) Telecommunication Standardization Sector (ITU-T) G.8275.1 Annex G.

In an embodiment, the network node may further comprise a third configuring module configured to configure a time period of measurement and a number of time periods.

In an embodiment, the network node may further comprise a first collecting module configured to collecting a first measurement data set.

In an embodiment, the network node may further comprise a second collecting module configured to collect a second measurement data set after the receiving link and the transmitting link of the first port are flipped.

In a fourth aspect of the disclosure, there is provided a computer program product, comprising instructions which, when executed on at least one processor, cause the at least one processor to carry out the method according to the first aspect.

In an fifth aspect of the disclosure, there is provided a computer-readable storage medium storing instructions which when executed by at least one processor, cause the at least one processor to carry out the method according to the first aspect.

Embodiments herein afford many advantages, of which a non-exhaustive list of examples follows. In some embodiments herein, it provides a new method to calculate the link asymmetry due to different physical path, e.g., different length of fiber, without additional device. In some embodiments herein, it could mitigate complexity of the sync deployment. In some embodiments herein, it does not need an additional device and activity to measure the link asymmetry of a port. In some embodiments herein, the link asymmetry of a port could be automatically calculated by flipping the RX link and TX link of a port and recorded on the network node. In some embodiments herein, the operator can choose to compensate the calculated asymmetry automatically or manually. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram illustrating an exemplary communication system into which an embodiment of the disclosure is applicable;

FIG. 2 is a diagram illustrating a Precision Time Protocol (PTP) network into which an embodiment of the disclosure is applicable;

FIG. 3 shows a PTP message exchange procedure according to an embodiment of the present disclosure;

FIG. 4 shows an example of time error introduced by link asymmetry according to an embodiment of the present disclosure;

FIG. 5 shows a flowchart of a method according to an embodiment of the present disclosure;

FIG. 6 shows an example of asymmetry introduced by different length of fiber before flipping the RX fiber and TX fiber according to an embodiment of the present disclosure;

FIG. 7 shows an example of asymmetry introduced by different length of fiber after flipping the RX fiber and TX fiber according to an embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of asymmetry delay measurement, calculation and compensation according to an embodiment of the present disclosure;

FIG. 11 is a block diagram showing an apparatus suitable for use in practicing some embodiments of the disclosure; and

FIG. 12 is a block diagram showing a network node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless or wired networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3rd Generation Partnership Project (3GPP). For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure.

The network function (NF) can be implemented in a network element (physical or virtual) of a communication network. For example, the network node can be implemented either as a network element on a dedicated hardware, as a software instance running on a dedicated hardware, or as a virtualized function instantiated on an appropriate platform, e.g. on a cloud infrastructure.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media—having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to IEEE (Institute of Electrical and Electronics Engineers) standard 1588™-2019, ITU-T G.8275.1 or ITU-T G.8271.1 being used as non-limiting examples for certain exemplary network device and network interface. As such, the description of exemplary embodiments given herein specifically refers to terminology which is directly related thereto. Such terminology is only used in the context of the presented non-limiting examples and embodiments, and does naturally not limit the present disclosure in any way. Rather, any other network device and network interface may equally be utilized as long as exemplary embodiments described herein are applicable.

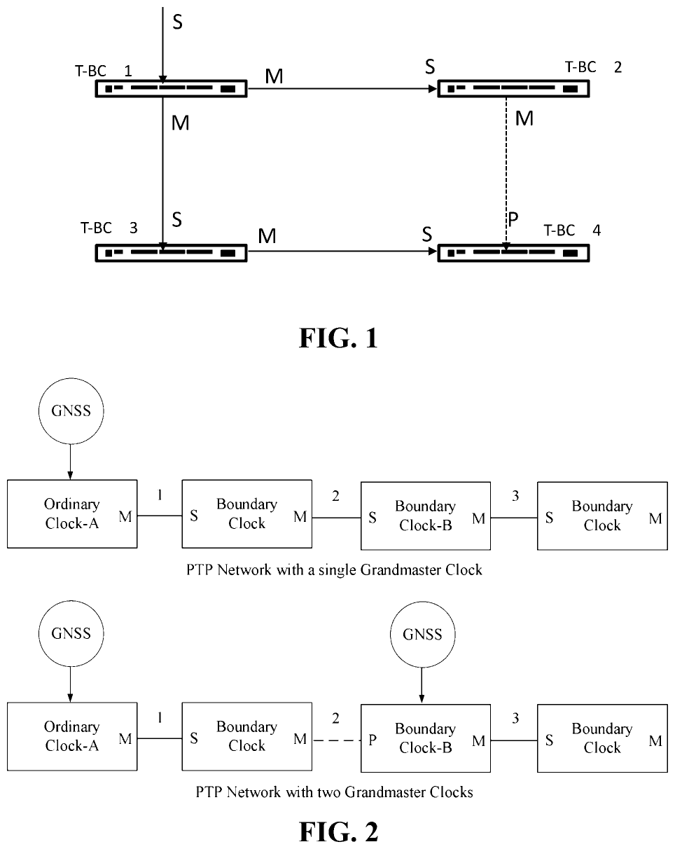

FIG. 1 is a diagram illustrating an exemplary communication system into which an embodiment of the disclosure is applicable.

As shown, the communication system may comprise four Telecom Boundaiy Clocks (TB-Cs), e.g., T-BC 1, T-BC 2, T-BC 3 and T-BC 4. For T-BC 4, there is a slave port (denoted as “S”) to get time and phase from a master port (denoted as “M”) of T-BC 2. There is also a passive port (denoted as “P”) to get time and phase from a master port of T-BC 3. For T-BC 2 and T-BC 3, they have the same clock source T-BC 1. T-BC 4 could measure and monitor the time error between Slave port and Passive port and raise an alarm if the time error exceeds a defined threshold. It is note that though only four TB-Cs are shown in FIG. 1, there may be any suitable number of TB-Cs in other embodiments.

FIG. 2 is a diagram illustrating a Precision Time Protocol (PTP) network into which an embodiment of the disclosure is applicable. FIG. 2 is same as FIG. 15 of IEEE standard 1588™-2019.

In a PTP Network containing two or more Ordinary Clocks or Boundary Clocks with characteristics that qualify them as potential Grandmaster PTP Instances, the best master clock algorithm (BMCA) will segment the PTP Network such that the Local PTP Clocks of the PTP Instances in each segment synchronize to the Grandmaster Clock in that segment. This is illustrated in FIG. 2 where initially Ordinary Clock-A is the Grandmaster PTP Instance and there is a single domain.

When the clockClass of Boundary Clock-B upgrades, perhaps by obtaining time from a Global Navigation Satellite System (GNSS) system or other suitable system, the PTP Network splits into two domains separated, for example, by the connection number 2 and with a PTP Port in the PASSIVE state on Boundary Clock-B. Boundary Clock-B is now the Grandmaster PTP Instance for the domain for PTP Instances on the right side of connection-2, while Ordinary Clock-A remains the Grandmaster PTP Instance for PTP Instances on the left side of connection-2.

In FIG. 2, since both GNSS sources are a primary reference time source (i.e., same time), and PTP Instance Time accuracy can degrade as it passes through a Boundary Clock, the segmentation represents the best hierarchy. This sort of segmentation occurs when clockClass of each PTP Instance is 127 or less. If this sort of segmentation is not desired for a given application, clockClass greater than 127 can be used.

As used herein, boundary Clock may be a PTP instance that has multiple PTP Ports in a domain and maintains the timescale used in the domain. Within a domain, it may serve as the source of time to other PTP instances, that is, be a Master Clock, and it can in addition synchronize to another Boundary Clock or Ordinary Clock, that is, be a Slave Clock.

As used herein, clock may be a device that can provide a measurement of the passage of time since a defined epoch (e.g., the origin of a timescale).

As used herein, clock signal may be a physical signal that has periodic events. The periodic events mark the significant instants at which a time counter is incremented. The clock signal is characterized by its frequency and phase.

As used herein, network node may be an entity implementing some functionality, for example, a clock, a Boundary Clock, an encoder, and a port.

As used herein, PTP Network may be a network consisting of a combination of PTP Nodes and possibly non-PTP devices and/or PTP Management Node(s). Non-PTP devices include, for example, some bridges, routers, and other infrastructure devices, and possibly devices such as computers, printers, and other application devices.

As used herein, PTP Node may be a device that contains one or more PTP Instances and/or PTP services (e.g., Common Mean Link Delay Service).

PTP use the event message to carry timestamps between master and slave clocks to time calculation.

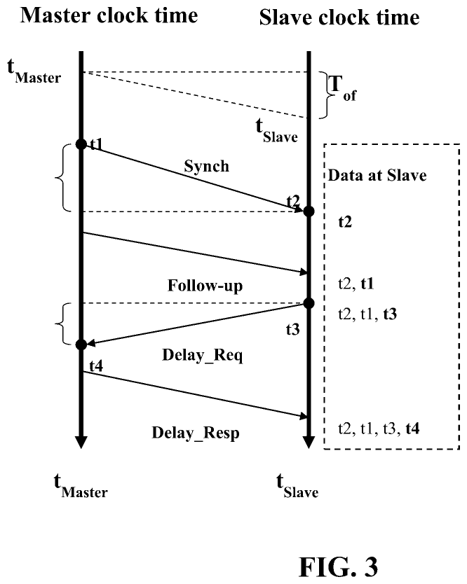

FIG. 3 shows a PTP message exchange procedure according to an embodiment of the present disclosure.

The Master PTP Instance sends a Synch message to the Slave PTP Instance and notes the time t1 at which it was sent.

The Slave PTP Instance receives the Synch message and notes the time of reception t2.

The Master PTP Instance conveys to the Slave PTP Instance the timestamp t1 by:
1) Embedding the timestamp t1 in the Sync message, or
2) Embedding the timestamp t1 in a Follow_Up message.

The Slave PTP Instance sends a Delay_Req message to the Master PTP Instance and notes the time t3 at which it was sent.

The Master PTP Instance receives the Delay_Req message and notes the time of reception t4.

The Master PTP Instance conveys to the Slave PTP Instance the timestamp t4 by embedding it in a Delay_Resp message.

At the conclusion of this exchange of PTP messages, the Slave PTP Instance possesses all four timestamps. These timestamps may be used to compute the offset of the Slave Clock with respect to the Master Clock.

$$t 2 - t 1 = Dms + T o f \qquad ( 1 )$$

$$t 4 - t 3 = Dms - T o f \qquad ( 2 )$$

Dms denotes the propagation delay from Master clock to Slave clock (unknown).

Dsm denotes the propagation delay from Slave clock to Master clock (unknown).

Tof denotes a time offset of Slave clock.

Combining the above two equations, it can obtain equation 3:

$$T o f = ( t 2 - t 1 - t 4 + t 3 ) / 2 + ( Dsm - Dms ) / 2 \qquad ( 3 )$$

If we can suppose Dms=Dsm, then it is possible to exactly compute Tof.

Unfortunately, in real networks there are many reasons causing Dms≠Dsm (asymmetry):
Stochastic asymmetries (e.g. different network load in downstream vs upstream),
Deterministic asymmetries (e.g. different physical path in downstream vs upstream).

A proper algorithm in the slave clock can succeed in filtering out most of stochastic asymmetries, by working on a great numbers of measurement sets {t1(k), t2(k), t3(k), t4(k), k=1, . . . , N}. For ITU-T G.8275.1, it is full timing support profile. There is usually no stochastic asymmetries.

Deterministic asymmetries can only be removed if they are computed/measured with other methods, otherwise Tof estimation will result errored by: ε=(Dsm−Dms)/2.

In ITU-T G.8275.1 Annex G, a PTP clock must synchronize only to a PTP port of its parent clock that is in the MASTER state. The synchronization must be received on, and only on, the port of the PTP clock that is in the SLAVE state. However, in some instances it may be desirable for a PTP port in the PASSIVE state to receive time information from its peer, which is in the MASTER state.

When a PTP port is in the PASSIVE state, the PTP port may transmit Delay_Req messages with the alternateMasterFlag value set to FALSE. A PTP port that receives a Delay_Req message, if it is in the MASTER state, responds with a Delay_Resp message with alternateMasterFlag value to set to FALSE. When a PTP PASSIVE port gets the Sync and Delay_Resp message from another PTP MASTER port, this PTP clock can get the time error based on PTP timestamps of PASSIVE port. If the difference of the time error of PASSIVE port and the time error of SLAVE port exceeds a threshold, this PTP clock may generate an alarm, which means that a fiber asymmetric, or a clock failure could be present in this PTP network.

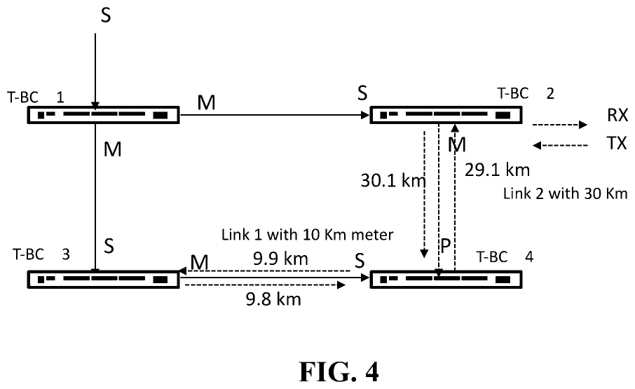

FIG. 4 shows an example of time error introduced by link asymmetry according to an embodiment of the present disclosure.

With Sync deployment shown in FIG. 4, T-BC 1, T-BC 2 and T-BC 3 are in the same or close site, however, T-BC 4 is located in a remote site. The length of fiber of Link 1 between T-BC 2 and T-BC 4 is about 30 Km, and the length of Link 2 between T-BC 3 and T-BC 4 is about 10 Km.

For Link 1, due to the different length of fiber, the Dsm and Dms are different, according to the equation 3 mentioned above, Tof estimation will result errored by:

$$ε = ( Dsm - Dms ) / 2 = ( 9900 * 5 ns - 9800 * 5 ns ) / 2 = 250 ns$$

ε is the TE introduced by the link asymmetry.

The link asymmetry could be removed by using a device to measure and compensate it, for example, OTDR. But the device needs cost and complex. ODTR also may not measure the actual port to port fiber length between T-BCs.

For example, operators need to record each fiber length and compensate it manually.

For link 2, with the same method, the TE should be −2500 ns.

If a customer want to measure the difference of the time error of PASSIVE port and the time error of SLAVE port according to ITU-T G.8275.1 Annex G, the customer will get a wrong result due to the link asymmetry.

To overcome or mitigate at least one of the above mentioned problems or other problems, an improved solution for determining link asymmetry delay may be desirable.

In an embodiment, it proposes a new method by using two groups of measurement data with flipping the receiving link and transmitting link, to calculate the asymmetry of the link. Operators may choose automatically or manually compensate the asymmetry according to the calculated result.

In an embodiment, it provides a new method to calculate the link asymmetry due to different physical path, e.g., different length of fiber, without additional device. It could mitigate complexity of the sync deployment.

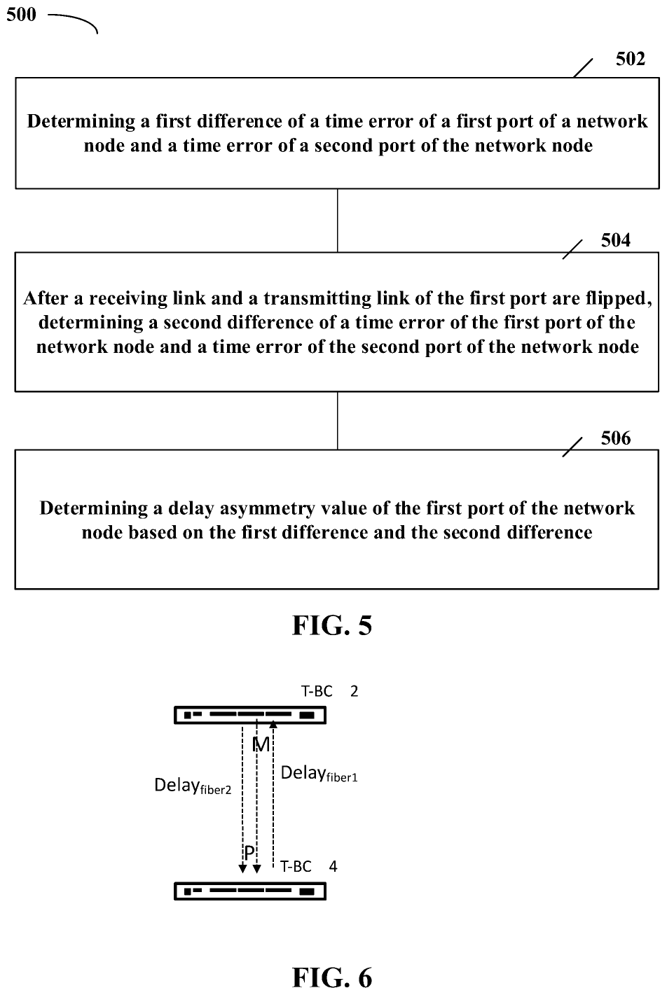

FIG. 5 shows a flowchart of a method according to an embodiment of the present disclosure, which may be performed by an apparatus implemented in or as or communicatively coupled to a network node or any other entity having similar functionality. As such, the network node may provide means or modules for accomplishing various parts of the method 500 as well as means or modules for accomplishing other processes in conjunction with other components.

At block 502, the network node may determine a first difference of a time error of a first port of a network node and a time error of a second port of the network node.

The network node may refer to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network node may be an access network node with accessing function in a communication network via which a terminal device accesses to the network and receives services therefrom. The access network node may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (TAB) node, a remote radio head (RRH), a relay, a low power node such as a femto, a pico, and so forth.

Yet further examples of the access network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The first port of the network node may be a PTP port in a slave state or passive state which can receive a timing signal from a port of another network node which is in a master state.

For example, the PTP Port states determining the master-slave hierarchy are as follows:
a) MASTER: The PTP Port is the source of time on the PTP Communication Path served by the PTP Port.
b) SLAVE: The PTP Port synchronizes to the PTP Port on the PTP Communication Path that is in the MASTER state.
c) PASSIVE: The PTP Port is not the source of time on the PTP Communication Path nor does it synchronize to a Master Clock.

The time error between a Slave Clock and a Master Clock is defined as follows:

<offsetFromMaster>=<Time on the Slave Clock>−<Time on the Master Clock>

In an embodiment, the first port is a PTP port in a slave state and the second port is a PTP port in a passive state.

In an embodiment, the first port is a PTP port in a passive state and the second port is a PTP port in a slave state, or

In an embodiment, the first port is a PTP port in a passive state and the second port is a PTP port in a passive state.

In an embodiment, a timing signal received by the first port and the second port comprises a timing signal of a Precision Time Protocol (PTP) clock.

The network node may determine the first difference of a time error of a first port of a network node and a time error of a second port of the network node in various ways.

In an embodiment, the time error may be measured by the network node. For example, the time error may be measured by reception and transmission of event messages for carrying timestamps between a master clock and a slave clock.

In the context of a single communication path, master clock is the source of time to which all other local clocks on that communication path synchronize.

In the context of a single communication path, slave clock synchronizes to the master lock on that communication path.

For example, the time error may be measured according to the PTP message exchange procedure as shown in FIG. 3. For example, if we suppose Dms=Dsm, then Tof can be calculated by equation 4.

$$T o f = ( t 2 - t 1 - t 4 + t 3 ) / 2 \qquad ( 4 )$$

In an embodiment, the time error is obtained from a time error measurement device. The time error measurement device may be any suitable device which can measure the time error. For example, the time error measurement device may be oscillography, Paragon-X, Paragon NEO, etc.

In an embodiment, the first difference is an average value of two or more first differences of two or more time errors of the first port and two or more time errors of the second port. For example, two or more measurement data sets may be collected and two or more first differences may be obtained, and then the average value of two or more first differences may be obtained.

Unfortunately, in real networks there are many reasons causing Dms≠Dsm (asymmetry). The embodiments of the present disclosure will provide a new way to determine the delay asymmetry value of the first port of the network node.

At block 504, after a receiving link and a transmitting link of the first port are flipped, the network node may determine a second difference of a time error of the first port of the network node and a time error of the second port of the network node.

The receiving link and the transmitting link of the first port may be flipped by the network node or an operator.

For example, after the network node determine first difference of a time error of a first port of a network node and a time error of a second port of the network node, the receiving link and the transmitting link of the first port may be flipped. Then similarly the network node may determine the second difference of a time error of the first port of the network node and a time error of the second port of the network node.

The receiving link and the transmitting link may be any suitable link. In an embodiment, the receiving link may comprise a fiber link and/or the transmitting link may comprise a fiber link.

In an embodiment, the second difference is an average value of two or more second differences of two or more time errors of the first port and two or more time errors of the second port. For example, two or more measurement data sets may be collected and two or more second differences may be obtained, and then the average value of two or more second differences may be obtained.

At block 506, the network node may determine a delay asymmetry value of the first port of the network node based on the first difference and the second difference.

In an embodiment, the network node may determine the delay asymmetry value of the first port of the network node by the second difference subtracting the first difference.

Take the case shown in FIG. 4 for example.

Since the Slave port and Passive port finally come from the same T-BC 1, the related TE of two PTP port on T-BC 1 is very small compared to the error introduced by fiber asymmetry delay and could be ignored. The cTE on slave port should be

$$c T {E}_{S} = c T {E}_{t - bc 3} + c T {E}_{t - bc 4 S} + T {E}_{link 1}$$

cTE_{S}: Constant Time Error of Slave port on T-BC 4 from T-BC 1
cTE_{t-bc 3}: Constant Time Error introduced by T-BC 3
cTE_{t-bc 4 S}: Constant Time Error introduced by Slave port on T-BC 4
TEₗᵢₙₖ₁: Time Error introduced by the link 1 asymmetry

Same for Passive port as below

$$c T {E}_{p} = c T {E}_{t - bc 2} + c T {E}_{t - bc 4 P} + T {E}_{link 2}$$

cTEₚ: Constant Time Error of Passive port on T-BC 4 from T-BC 1
cTE_{t-bc 2}: Constant Time Error introduced by T-BC 2
cTE_{t-bc 4 P}: Constant Time Error introduced by Passive port on T-BC 4
TEₗᵢₙₖ₂: Time Error introduced by the link 2 asymmetry

According to the IYU-T G.8275.1 Annex G, Slave port is configured as the reference for measure the difference, Passive port is the monitored Port. The Time Error difference of Slave port and Passive port could be collected. These data could be collected in a period, for example, 5 minutes, 15 minutes, 60 minutes, or 24 hours. With a period of record, software could calculate the average of the Time Error difference.

Here, the average of Time Error difference is approximate to

$$c T {E}_{p} - c T {E}_{S} = T {E}_{MeasureDiff}$$

That could be

$$T {E}_{MeasureDiff} = ( c T {E}_{t - bc 2} + c T {E}_{t - bc 4 P} + T {E}_{link 2} ) - ( c T {E}_{t - bc 3} + c T {E}_{t - bc 4 S} + T {E}_{link 1} )$$

$$T {E}_{MeasureDiff} = ( ( c T {E}_{t - bc 2} + c T {E}_{t - bc 4 P} ) - ( c T {E}_{t - bc 3} + c T {E}_{t - bc 4 S} ) - T {E}_{link 1} ) + T {E}_{link 2}$$

FIG. 6 shows an example of asymmetry introduced by different length of fiber before flipping the RX fiber and TX fiber according to an embodiment of the present disclosure.

$$T E link 2 ( 1 ) = ( Dsm - Dms ) / 2 = ( Delayfiber 1 - Delayfiber 2 ) / 2$$

Then TE MeasureDiff (1) could be collected and calculated in a period. It should be an average value of TE in a period.

$$T {E}_{link 2} ( 1 ) = ( Dsm - Dms ) / 2 = ( {Delay}_{fiber 1} - {Delay}_{fiber 2} ) / 2$$

Then TE MeasureDiff (1) could be collected and calculated in a period. It may be an average value of TE in a period.

$$T {E}_{MeasureDiff} ( 1 ) = ( ( c T {E}_{t - bc 2} + c T {E}_{t - bc 4 P} ) - ( c T {E}_{t - bc 3} + c T {E}_{t - bc 4 S} ) - T {E}_{link 1} ) + ( {Delay}_{fiber 1} - {Delay}_{fiber 2} ) / 2$$

For a stable PTP system above, Time Error is coming from the asymmetry due to different length of TX and RX fiber. The average of Time Error difference is also stable with very small variation. If flipping the TX and RX fiber, the asymmetry will be an opposite value. And a new Time Error difference value could be measurement.

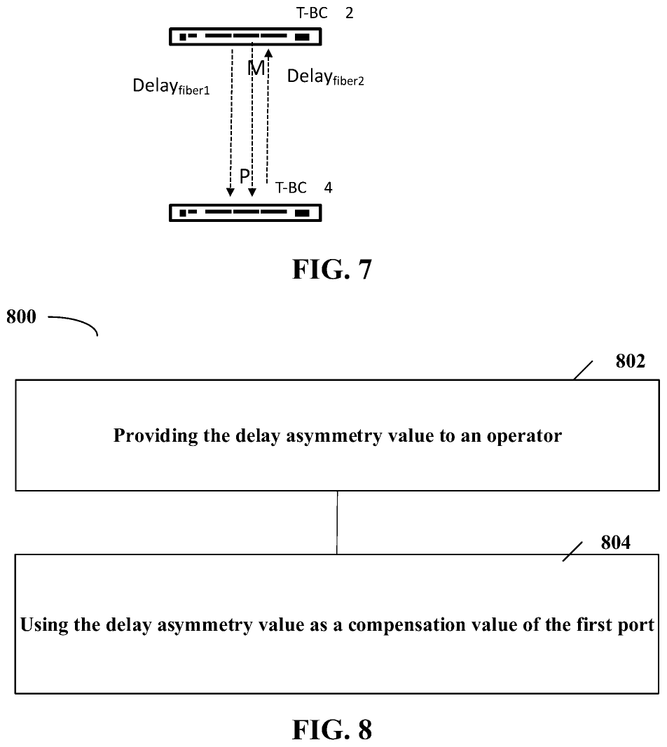

FIG. 7 shows an example of asymmetry introduced by different length of fiber after flipping the RX fiber and TX fiber according to an embodiment of the present disclosure.

After flipping the RX fiber and TX fiber as shown in FIG. 7,

$$T {E}_{link 2} ( 2 ) = ( Dsm - Dms ) / 2 = ( {Delay}_{fiber 2} - {Delay}_{fiber 1} ) / 2$$

Then TE MeasureDiff (2) could be collected and calculated in a period. It may be an average value of TE in a period.

$$T {E}_{MeasureDiff} ( 2 ) = ( ( c T {E}_{t - bc 2} + c T {E}_{t - bc 4 P} ) - ( c T {E}_{t - bc 3} + c T {E}_{t - bc 4 S} ) - T {E}_{link 1} ) + ( {Delay}_{fiber 2} - {Delay}_{fiber 1} ) / 2$$

Here, it is consumed that during the fiber flipping, ((cTE_{t-bc 2}+cTE_{t-bc 4 P})−(cTE_{t-bc 3}+cTE_{t-bc 4 S})−TEₗᵢₙₖ₁) would not change or changed in a very small variation.

Then using

$$T {E}_{MeasureDiff} ( 2 ) - T {E}_{MeasureDiff} ( 1 ) = ( ( ( c T {E}_{t - bc 2} + c T {E}_{t - bc 4 P} ) - ( c T {E}_{t - bc 3} + c T {E}_{t - bc 4 S} ) - T {E}_{link 1} ) + ( {Delay}_{fiber 1} - {Delay}_{fiber 2} ) / 2 ) - ( ( ( c T {E}_{t - bc 2} + c T {E}_{t - bc 4 P} ) - ( c T {E}_{t - bc 3} + c T {E}_{t - bc 4 S} ) - T {E}_{link 1} ) + ( {Delay}_{fiber 2} - {Delay}_{fiber 1} ) / 2 ) = ( {Delay}_{fiber 1} - {Delay}_{fiber 2} ) / 2 ) - ( {Delay}_{fiber 2} - {Delay}_{fiber 1} ) / 2 ) = {Delay}_{fiber 1} - {Delay}_{fiber 2}$$

As a summary, by this method, Delayfiber1−Delayfiber2 could be got from TE_{MeasureDiff}(2)−TE_{MeasureDiff}(1). It could directly use Delay_{fiber1}−Delay_{fiber2} as the compensation value or provide it to an operator.

Table 1 is a simulation result from a real topology. Each measurement period is 15 minutes. And average value is the average of two periods.

TABLE 1
simulation result of the asymmetry calculation

| | | Measured Time Difference Information: | | | | | | | DELAY ASYMMETRY = |
|---|---|---|---|---|---|---|---|---|---|
| | | Source | StdDev | Min | Max | | | AVERAGE | MEASUREMENT#2 − |
| | | (ns) | (ns) | (ns) | (ns) | Average | | TE | MEASUREMENT#1 |
| Test | Reference: | Port 2 | . | 1106 | 1124 | 1112 | 2 | 1112 | −1226 − |
| case | 10KM LR4 | | . | | | | | | 1112 = −2338 |
| | to T-BC 2 | | . | | | | | | |
| | Monitor: | Port 2 | . | 1106 | 1122 | 1112 | 2 | | |
| | 10KM LR4 | | . | | | | | | |
| | to T-BC 3 | | . | | | | | | |
| | Switch | Port 2 | . | −1235 | −1215 | −1227 | 3 | −1226 | |
| | TX/RX for | | . | | | | | | |
| | monitor | | . | | | | | | |
| | T-BC 3 | Port 2 | . | −1232 | −1214 | −1225 | 2 | | |
| | | | . | | | | | | |
| | | | . | | | | | | |

From customer point of view, there should be a command to trigger the first measurement and enable or disable automatic compensation. With this command, customer also could configure the period to collect the measurement data and number of periods to calculate the average value.

There should be another command to trigger the second measurement after flipping the RX/TX fiber.

After the second measurement is finished, asymmetry delay will be calculated. The asymmetry could be shown by command, and customer will decide whether to compensate it.

Take the test result show on table 1 for example, the delay asymmetry should be

$$Asymmetry = {Delay}_{fiber 1} - {Delay}_{fiber 2} = T {E}_{MeasureDiff} ( 2 ) - T {E}_{MeasureDiff} ( 1 ) = - 1226 ns - 1112 ns = - 2338 ns$$

That means the asymmetry on Slave port is −2338 ns, operator could configure asymmetry delay compensation on Slave port as −2338 ns.

FIG. 8 shows a flowchart of a method according to another embodiment of the present disclosure, which may be performed by an apparatus implemented in or as or communicatively coupled to a network node or any other entity having similar functionality. As such, the network node may provide means or modules for accomplishing various parts of the method 800 as well as means or modules for accomplishing other processes in conjunction with other components. For some parts which have been described in the above embodiments, detailed description thereof is omitted here for brevity.

At block 802, the network node may provide the delay asymmetry value to an operator. For example, the network node may provide the delay asymmetry value to an operator via file, message, Email, etc. Then the operator may decide whether to use the delay asymmetry value as a compensation value of the first port.

At block 804, the network node may use the delay asymmetry value as a compensation value of the first port. The network node may automatically use the delay asymmetry value as a compensation value of the first port.

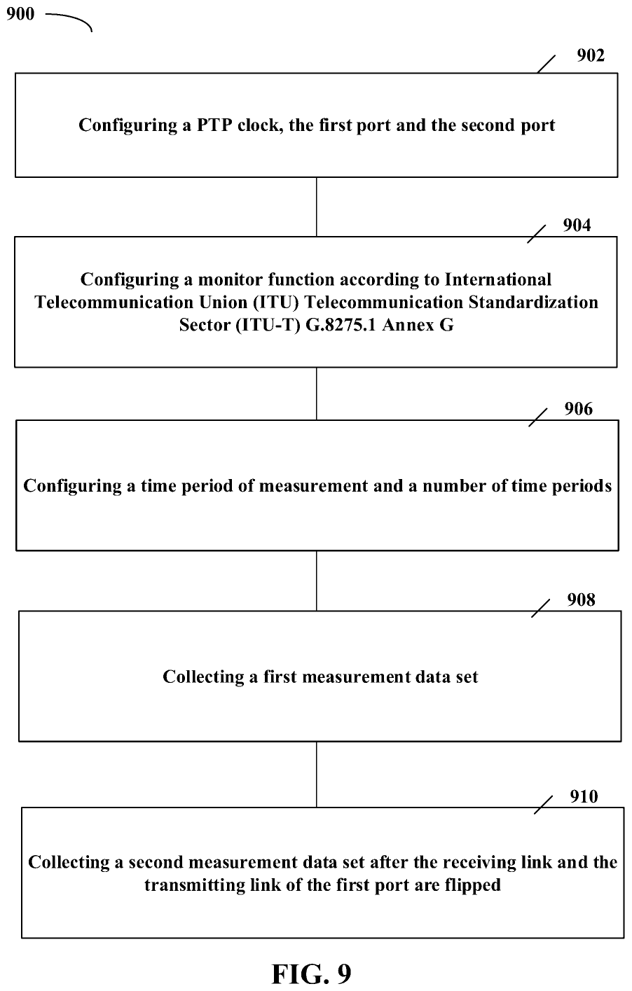

FIG. 9 shows a flowchart of a method according to an embodiment of the present disclosure, which may be performed by an apparatus implemented in or as or communicatively coupled to a network node or any other entity having similar functionality. As such, the network node may provide means or modules for accomplishing various parts of the method 900 as well as means or modules for accomplishing other processes in conjunction with other components. For some parts which have been described in the above embodiments, detailed description thereof is omitted here for brevity.

At block 902, the network node may configure a PTP clock, the first port and the second port.

At block 904, the network node may configure a monitor function according to International Telecommunication Union (ITU) Telecommunication Standardization Sector (ITU-T) G.8275.1 Annex G;

At block 906, the network node may configure a time period of measurement and a number of time periods.

At block 908, the network node may collect a first measurement data set. For example, the first measurement data set may be used to determine a first difference of a time error of a first port of a network node and a time error of a second port of the network node.

At block 910, the network node may collect a second measurement data set after the receiving link and the transmitting link of the first port are flipped. For example, the second measurement data set may be used to determine a second difference of a time error of the first port of the network node and a time error of the second port of the network node.

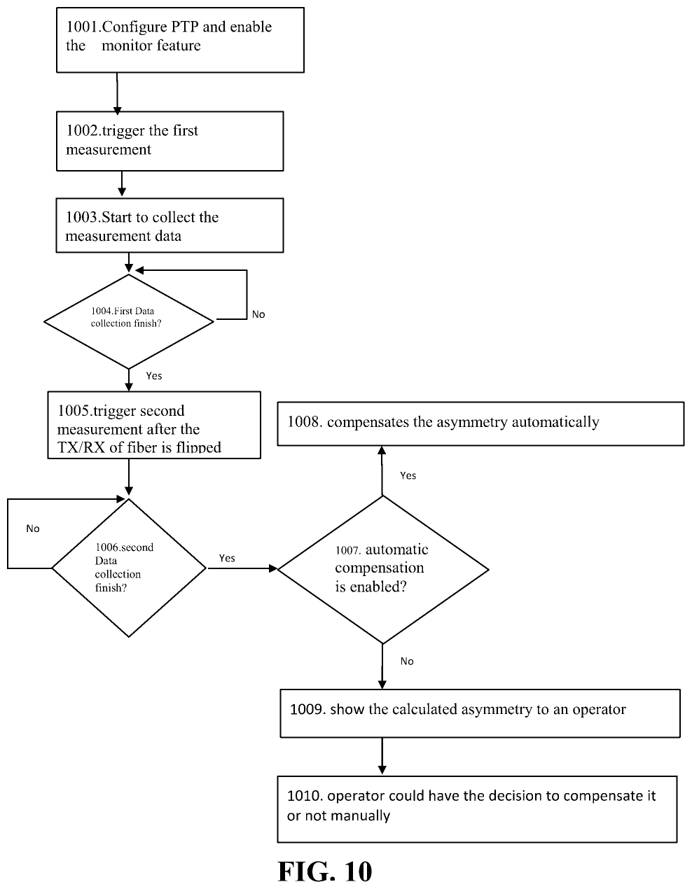

FIG. 10 shows a flowchart of asymmetry delay measurement, calculation and compensation according to an embodiment of the present disclosure.

At block 1001, the network node may configure PTP clock and port, and configure the monitor function defined in G.8275.1 Annex G. Then wait PTP is locked.

At block 1002, the network node may trigger the first measurement. For example, the network node may trigger the asymmetry calculation process and configure the period of measurement and number of the period.

At block 1003, the network node (such as asymmetry calculation module may) may start to collect the measurement data for the monitored port.

How long of the period for the collection duration is and how many periods are needed are decided by the configuration. Customer could check the show information to know whether the collection of first data is finished.

At block 1004, the network node determines whether the first data collection is finished.

At block 1005, when the first data collection is finished, the network node (such as asymmetry calculation module) may trigger a second measurement after the TX/RX of fiber is flipped.

For example, the customer may flip the TX and RX of fiber. The asymmetry calculation module) may go on to collect the second data for the case flipping the TX and RX.

At block 1006, the network node determines whether the second data collection is finished.

At block 1007, when second data collection is finished, the network node may check whether automatic compensation is enabled.

At block 1008, if automatic compensation is enabled, the network node (such as software (SW)) compensates the asymmetry automatically. For example, the calculated asymmetry may be automatically applied to this PTP port.

At block 1009, if automatic compensation is disabled, the calculated asymmetry is shown to an operator.

At block 1010, the operator could have the decision to compensate it or not manually.

Embodiments herein afford many advantages, of which a non-exhaustive list of examples follows. In some embodiments herein, it provides a new method to calculate the link asymmetry due to different physical path, e.g., different length of fiber, without additional device. In some embodiments herein, it could mitigate complexity of the sync deployment. In some embodiments herein, it does not need an additional device and activity to measure the link asymmetry of a port. In some embodiments herein, the link asymmetry of a port could be automatically calculated by flipping the RX link and TX link of a port and recorded on the network node. In some embodiments herein, the operator can choose to compensate the calculated asymmetry automatically or manually. The embodiments herein are not limited to the features and advantages mentioned above. A person skilled in the art will recognize additional features and advantages upon reading the following detailed description.

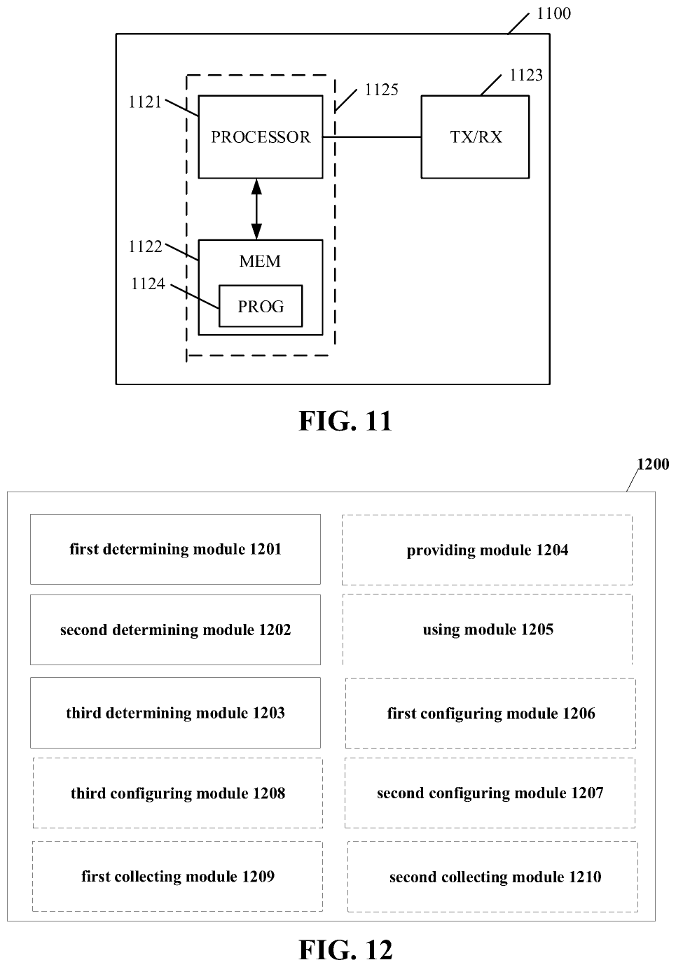

FIG. 11 is a block diagram showing an apparatus suitable for use in practicing some embodiments of the disclosure. For example, the network node described above may be implemented through the apparatus 1100.

The apparatus 1100 comprises at least one processor 1121, such as a DP, and at least one MEM 1122 coupled to the processor 1121. The apparatus 1120 may further comprise a transmitter TX and receiver RX 1123 coupled to the processor 1121. The MEM 1122 stores a PROG 1124. The PROG 1124 may include instructions that, when executed on the associated processor 1121, enable the apparatus 1120 to operate in accordance with the embodiments of the present disclosure. A combination of the at least one processor 1121 and the at least one MEM 1122 may form processing means 1125 adapted to implement various embodiments of the present disclosure.

Various embodiments of the present disclosure may be implemented by computer program executable by one or more of the processor 1121, software, firmware, hardware or in a combination thereof.

The MEM 1122 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1121 may be of any type suitable to the local technical environment, and may include one or more of general purpose computers, special purpose computers, microprocessors, digital signal processors DSPs and processors based on multicore processor architecture, as non-limiting examples.

In an embodiment where the apparatus is implemented as or at the network node, the memory 1122 contains instructions executable by the processor 1121, whereby the network node operates according to any of the methods performed by the network node.

FIG. 12 is a block diagram showing a network node according to an embodiment of the disclosure. As shown, the network node 1200 may comprise a first determining module 1201 configured to determine a first difference of a time error of a first port of a network node and a time error of a second port of the network node. The network node 1200 may further comprise a second determining module 1202 configured to determine a second difference of a time error of the first port of the network node and a time error of the second port of the network node after a receiving link and a transmitting link of the first port are flipped. The network node 1200 may further comprise a third determining module 1203 configured to determine a delay asymmetry value of the first port of the network node based on the first difference and the second difference.

In an embodiment, the network node 1200 may further comprise a providing module 1204 configured to provide the delay asymmetry value to an operator.

In an embodiment, the network node 1200 may further comprise a using module 1205 configured to using the delay asymmetry value as a compensation value of the first port.

In an embodiment, the network node 1200 may further comprise a first configuring module 1206 configured to configure a PTP clock, the first port and the second port.

In an embodiment, the network node 1200 may further comprise a second configuring module 1207 configured to configure a monitor function according to International Telecommunication Union (ITU) Telecommunication Standardization Sector (ITU-T) G.8275.1 Annex G.

In an embodiment, the network node 1200 may further comprise a third configuring module 1208 configured to configure a time period of measurement and a number of time periods.

In an embodiment, the network node 1200 may further comprise a first collecting module 1209 configured to collecting a first measurement data set.

In an embodiment, the network node 1200 may further comprise a second collecting module 1210 configured to collect a second measurement data set after the receiving link and the transmitting link of the first port are flipped.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a network node, the method comprising:
determining a first difference of a time error of a first port of a network node and a time error of a second port of the network node;
after a receiving link and a transmitting link of the first port are flipped, determining a second difference of a time error of the first port of the network node and a time error of the second port of the network node; and
determining a delay asymmetry value of the first port of the network node based on the first difference and the second difference.

2. The method according to claim 1, wherein determining a delay asymmetry value of the first port of the network node based on the first difference and the second difference comprises:
determining the delay asymmetry value of the first port of the network node by the second difference subtracting the first difference.

3. The method according to claim 1, further comprising one or both:
providing the delay asymmetry value to an operator; and
using the delay asymmetry value as a compensation value of the first port.

4. The method according to claim 1, wherein one or both:
the first difference is an average value of two or more first differences of two or more time errors of the first port and two or more time errors of the second port; and
the second difference is an average value of two or more second differences of two or more time errors of the first port and two or more time errors of the second port.

5. The method according to claim 1, wherein the time error is measured by the network node or obtained from a time error measurement device.

6. The method according to claim 5, wherein the time error is measured by reception and transmission of event messages for carrying timestamps between a master clock and a slave clock.

7. The method according to claim 1, wherein a timing signal received by the first port and the second port comprises a timing signal of a Precision Time Protocol, PTP, clock.

8. The method according to claim 1, wherein:
the first port is a PTP port in a slave state and the second port is a PTP port in a passive state; or
the first port is a PTP port in a passive state and the second port is a PTP port in a slave state; or
the first port is a PTP port in a passive state and the second port is a PTP port in a passive state.

9. The method according to claim 1, wherein one or both:
the receiving link comprises a fiber; and
the transmitting link comprises a fiber link.

10. The method according to claim 1, further comprising:
configuring a PTP clock, the first port and the second port;
configuring a monitor function according to International Telecommunication Union, ITU, Telecommunication Standardization Sector, ITU-T, G.8275.1 Annex G;
configuring a time period of measurement and a number of time periods;
collecting a first measurement data set; and
collecting a second measurement data set after the receiving link and the transmitting link of the first port are flipped.

11. A network node, comprising:
a processor; and
a memory coupled to the processor, the memory containing instructions executable by aid the processor, whereby the network node is operative to:
determine a first difference of a time error of a first port of a network node and a time error of a second port of the network node;
after a receiving link and a transmitting link of the first port are flipped, determine a second difference of a time error of the first port of the network node and a time error of the second port of the network node; and
determine a delay asymmetry value of the first port of the network node based on the first difference and the second difference.

12.-14. (canceled)

15. The method according to claim 2, further comprising one or both:
providing the delay asymmetry value to an operator; and
using the delay asymmetry value as a compensation value of the first port.

16. The method according to claim 2, wherein one or both:
the first difference is an average value of two or more first differences of two or more time errors of the first port and two or more time errors of the second port; and
the second difference is an average value of two or more second differences of two or more time errors of the first port and two or more time errors of the second port.

17. The method according to claim 2, wherein the time error is measured by the network node or obtained from a time error measurement device.

18. The method according to claim 17, wherein the time error is measured by reception and transmission of event messages for carrying timestamps between a master clock and a slave clock.

19. The method according to claim 2, wherein a timing signal received by the first port and the second port comprises a timing signal of a Precision Time Protocol, PTP, clock.

20. The method according to claim 2, wherein:
the first port is a PTP port in a slave state and the second port is a PTP port in a passive state; or
the first port is a PTP port in a passive state and the second port is a PTP port in a slave state; or
the first port is a PTP port in a passive state and the second port is a PTP port in a passive state.

21. The method according to claim 2, wherein one or both:
the receiving link comprises a fiber link; and
the transmitting link comprises a fiber link.

22. The method according to claim 2, further comprising:
configuring a PTP clock, the first port and the second port;
configuring a monitor function according to International Telecommunication Union, ITU, Telecommunication Standardization Sector, ITU-T, G.8275.1 Annex G;
configuring a time period of measurement and a number of time periods;
collecting a first measurement data set; and
collecting a second measurement data set after the receiving link and the transmitting link of the first port are flipped.

23. The method according to claim 3, wherein one or both:
the first difference is an average value of two or more first differences of two or more time errors of the first port and two or more time errors of the second port; and
the second difference is an average value of two or more second differences of two or more time errors of the first port and two or more time errors of the second port.
